(19) United States
(12) Patent Application Publication
(10) Pub. No.: US 2017/0152344 A1
(43) Pub. Date: Jun. 1, 2017

(54) FUNCTIONAL GRAPHENE NANOSTRUCTURE DEVICES FROM LIVING POLYMERS

(71) Applicant: The Regents of the University of California, Oakland, CA (US)

(72) Inventors: Felix Raoul Fischer, Berkeley, CA (US); Ryan Cloke, Berkeley, CA (US); Stephen von Kugelgen, Oakland, CA (US); Donatela Elsa Bellone, Berkeley, CA (US)

(73) Assignee: The Regents of the University of California, Oakland, CA (US)

(21) Appl. No.: 15/323,394

(22) PCT Filed: Jul. 20, 2015
(86) PCT No.: PCT/US15/41190

§ 371 Date: Dec. 30, 2016

Related U.S. Application Data
(60) Provisional application No. 62/026,662, filed on Jul. 20, 2014.

(51) Int. Cl. C08G 61/10

(52) U.S. Cl. CPC C08G 61/10; C01B 31/0446; C08G 2261/71; C08G 2261/78; C08G 2261/418; C08G 2261/312

(57) ABSTRACT

The disclosure provides methods to synthesize graphene based hetero-nanostructures, the graphene based hetero-nanostructures resulting therefrom, and devices comprising the graphene based hetero-nanostructures thereof.

### CROSS REFERENCE TO RELATED APPLICATIONS

This application claims priority under 35 U.S.C. §119 from Provisional Application Serial No. 62/026,662, filed Jul. 20, 2014, the disclosure of which is incorporated herein by reference.

### STATEMENT OF GOVERNMENT SUPPORT

This invention was made with Government support under Grant No. DE-SC0010409, awarded by the Department of Energy. The Government has certain rights in the invention.

### TECHNICAL FIELD

The disclosure provides methods to synthesize graphene based hetero-nanostructures, the graphene based hetero-nanostructures resulting therefrom, and devices comprising the graphene based hetero-nanostructures thereof.

### BACKGROUND

Over the last decade the evolution of scaling of dimensions, energy efficiency, and processor speed has slowed significantly due to the limitations imposed by a photolithographic top-down approach and the limited control of inorganic semiconductor material properties at sub 10 nm dimensions.

### SUMMARY

Disclosed herein are methods to fabricate atomically defined graphene nanostructures through a controlled ring-opening alkyne metathesis polymerization. The methods of the disclosure utilize a chain-growth polymerization that provides absolute control over the length, width, and symmetry; the doping pattern; and the segmentation of linear or cyclic graphene based hetero-nanostructures. The methods disclosed herein allow for the fabrication of atomically defined graphene based hetero-nanostructures featuring segments with modulated electronic band structure. The disclosure further provides that the graphene based hetero-nanostructures made by the methods of the disclosure can be used for a variety of applications, including in post silicon integrated circuit architectures.

In a particular embodiment, the disclosure provides a method to produce graphene based hetero-nanostructures comprising: subjecting a ring strained cycloalkynyl monomers to ring-opening alkyne polymerization conditions in the presence of a molybdenum ring-opening alkyne metathesis polymerization (ROAMP) catalyst. In a further embodiment, the polymerization conditions comprises a nonpolar solvent, such as pentane, cyclopentane, hexane, cyclohexane, benzene, toluene, 1,4-dioxane, chloroform, and diethyl ether, preferably toluene. In another embodiment, the ring strained cycloalkynyl monomers is selected from the structure of 1a, 1b and/or 1c:

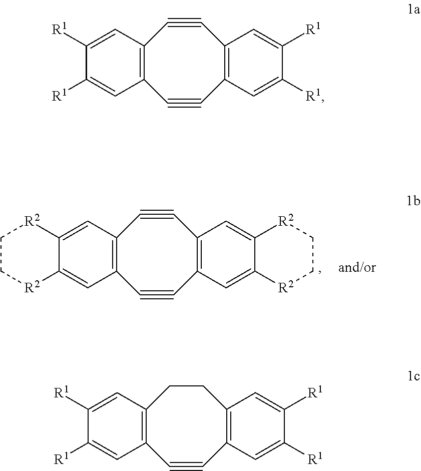

wherein, each R¹ is independently selected from hydrogen, optionally substituted alkyl, optionally substituted aryl, optionally substituted hetero-atom functional groups, or heteroaryls; and each R² is independently selected from benzannulated aromatic or aliphatic rings featuring hydrogen atoms, optionally substituted alkyl groups, optionally substituted aryl groups, optionally substituted heteroatom based functional groups, or optionally substituted heteroaromatic rings. In yet another embodiment, the molybdenum ROAMP catalyst is selected from the

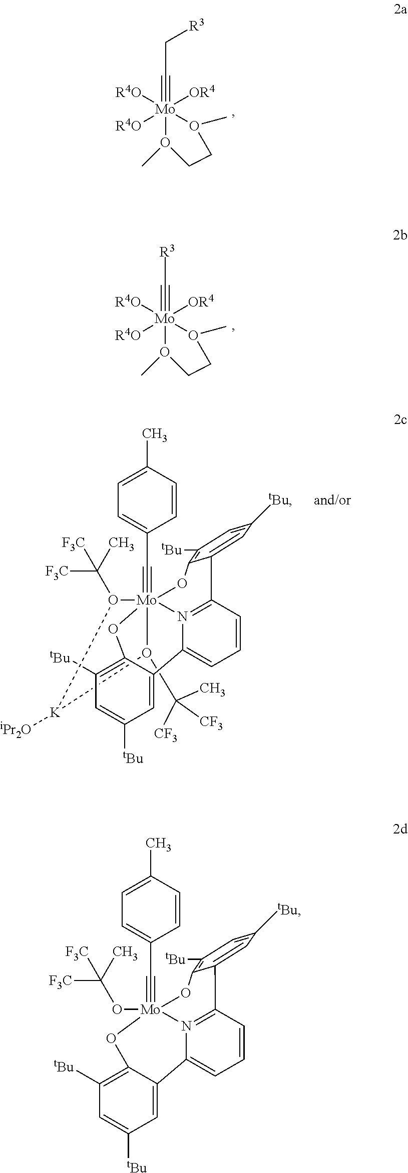

structure of 2a, 2b, 2c and/or 2d:

wherein, R³ is selected from optionally substituted alkyl, optionally substituted aryl, or optionally substituted heteroaryl; R⁴ is selected from C(CH₃)₃, C(CH₃)₂ (CF₃), C(CH₃) (CF₃)₂, or C(CF₃)₃.

In a certain embodiment, a method disclosed herein produces cyclic and/or linear poly(O-phenylene ethyneylene) (PoPE) hetero-nanostructures, wherein the cyclic PoPE hetero-nanostructures have 3 to 20 monomer units.

In a particular embodiment, a method of the disclosure comprises the step of separating cyclic and linear PoPE hetero-nanostructures by Shoxlet extraction.

In another embodiment, a method disclosed herein comprises the step of subjecting a cylic PoPE hetero-nanostructure or a linear PoPE hetero-nanostructure to a benzannulation reaction with a compound of structure 4a or 4b:

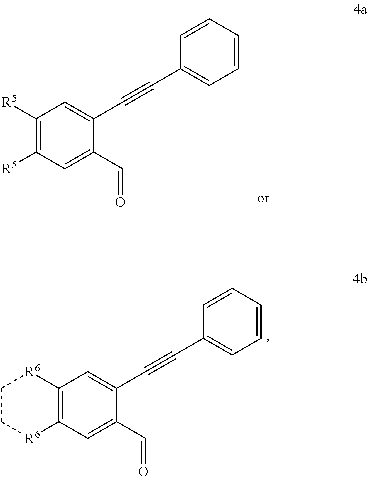

wherein, each R⁵ is independently selected from hydrogen, optionally substituted alkyl, optionally substituted aryl, NR₂, OR, F, Cl, Br, I, CN, NO₂, and optionally substituted heteroaryl; each R⁶ is independently selected from benzannulated aromatic or aliphatic rings featuring hydrogen atoms, optionally substituted alkyl groups, optionally substituted aryl groups, NR₂, OR, F, Cl, Br, I, CN, NO₂, and optionally substituted heteroaryl groups; and wherein each R is independently selected from optionally substituted alkyl, optionally substituted aryl, and optionally substituted heterocycle.

In a particular embodiment, a method of the disclosure comprises the step of oxidative cyclizing the benzannulated cylic PoPE hetero-nanostructure under Scholl reaction conditions to yield a [2n,2n] carbon nano-ring. In a further embodiment, the [2n,2n] carbon nano-ring is substituted with R¹ groups on one side of the ring, and substituted with R⁵ groups on the other side of the ring.

In an alternate embodiment, a method of the disclosure comprises the step of oxidative cyclizing a benzannulated linear PoPE hetero-nanostructure under Scholl reaction conditions to yield a graphene based nanoribbon (GNR). In a further embodiment, the two armchair edges of the GNR are substituted with R¹ groups on one side, and substituted with R⁵ or R⁶ groups on the other side.

In another alternate embodiment, a method of the disclosure comprises the step of oxidative cyclizing a benzannulated linear PoPE hetero-nanostructure under Scholl reaction conditions to yield a segmented graphene based nanoribbon (GNR), wherein the segments comprise block-copolymers featuring different monomer units. In a further embodiment, the segmented graphene based nanoribbon comprises tunneling junctions.

In a particular embodiment, the disclosure provides for a graphene based hetero-nanostructure made by a method of the disclosure.

In a further embodiment, the disclosure provides for a device which comprises a graphene based hetero-nanostructure of the disclosure. In a further embodiment, the device is a nanometer scale functional electronic device. In yet a further embodiment, the device is selected from a field effect transistor, tunneling transistor, and diode.

### DESCRIPTION OF DRAWINGS

FIG. 1A-B shows (A) presents ring-strained monomers and molybdenum ROAMP catalysts. (B) Synthesis of ROAMP catalyst 1. ORTEP representation of the X-ray crystal structure of 1. Thermal ellipsoids are drawn at the 50% probability level. Shown are: C, O, N, F, Mo. Hydrogen atoms are omitted for clarity. Diisopropyl ether was refined isotropically.

FIG. 2 provides an embodiment of an exemplary polymerization of 1a with catalyst 2a.

FIG. 3 presents a tracing of the polymerization reaction by ¹H NMR. Color code: black, monomer 1a; orange, intermediate metallacyclobutadiene; blue, propagating linear polymers 3a; red, regenerated catalyst 2a.

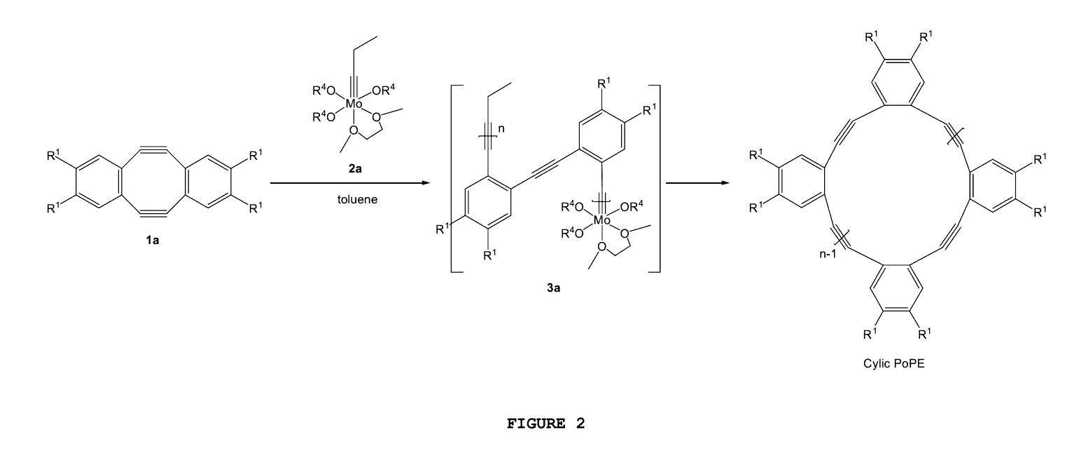

FIG. 4 presents a GPC tracing of cyclic polymers (red) and benzannulated cyclic polymers (blue).

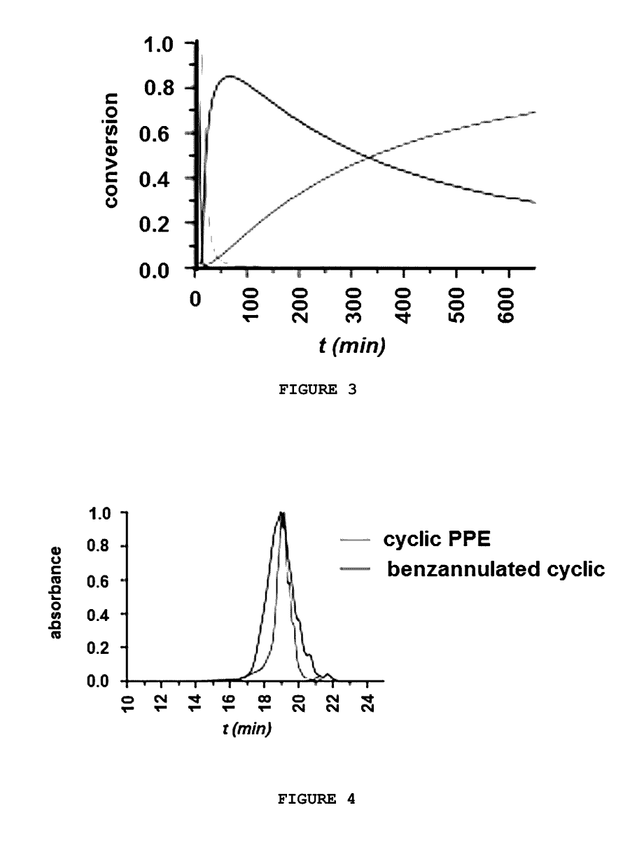

FIG. 5 presents reagents for the benzannulation reaction.

FIG. 6 provides an embodiment of an exemplary benzannulation reaction and oxidative cyclization to form carbon nanorings. (same substituents R¹ and R⁵ in the carbon nanoring are omitted for clarity)

FIG. 7 presents an embodiment of a synthesis of linear PoPE with catalyst 2b.

FIG. 8 presents an embodiment of an exemplary benzannulation reaction of linear PoPE and oxidative cyclization to form armchair GNRs.

FIG. 9 presents an embodiment of a synthesis of segmented GNRs from PoPE block copolymers.

FIG. 10 presents an embodiment of a synthesis of segmented GNRs through controlled chain-transfer with polyfunctional molecules.

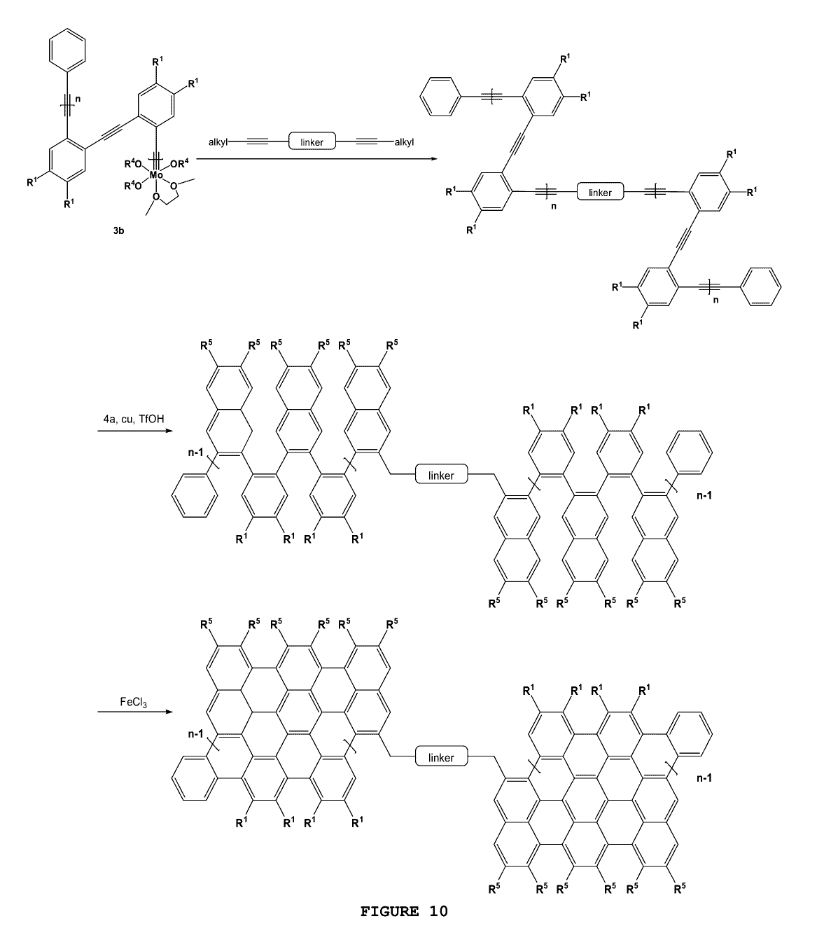

FIG. 11 presents a Segmented GNR featuring alternating pattern of AGNRs-ZGNRs-AGNRs.

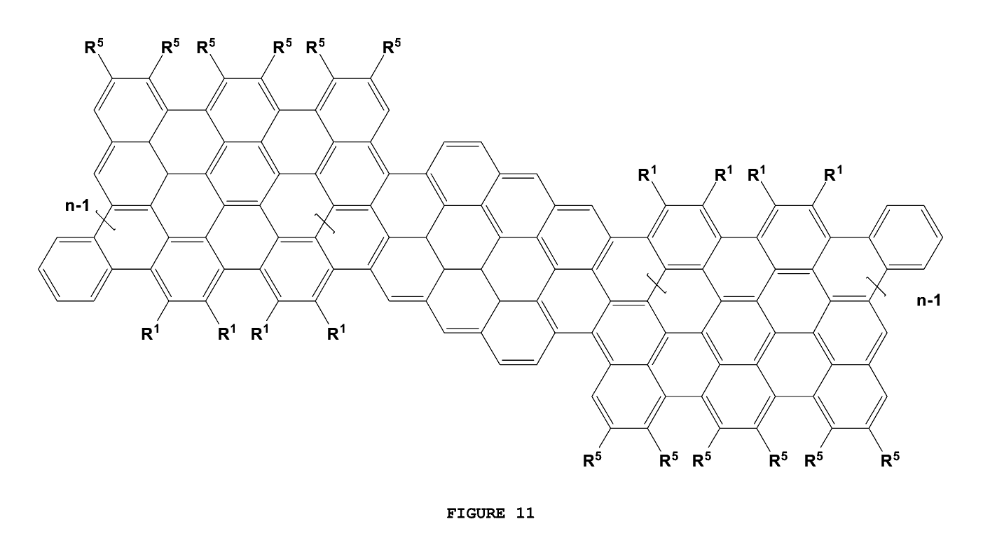

### DETAILED DESCRIPTION

As used herein and in the appended claims, the singular forms “a,” “and,” and “the” include plural referents unless the context clearly dictates otherwise. Thus, for example, reference to “a copolymer” includes a plurality of such materials and reference to “the nanostructure” includes reference to one or more nanostructures and equivalents thereof known to those skilled in the art, and so forth.

Unless defined otherwise, all technical and scientific terms used herein have the same meaning as commonly understood to one of ordinary skill in the art. Although many methods and reagents similar or equivalent to those described herein, the exemplary methods and materials are presented herein.

Also, the use of “or” means “and/or” unless stated otherwise. Similarly, “comprise,” “comprises,” “comprising” “include,” “includes,” and “including” are interchangeable and not intended to be limiting.

It is to be further understood that where descriptions of various embodiments use the term “comprising,” those skilled in the art would understand that in some specific instances, an embodiment can be alternatively described using language “consisting essentially of” or “consisting of.”

The publications discussed above and throughout the text are provided solely for their disclosure prior to the filing date of the present application. Nothing herein is to be construed as an admission that the inventors are not entitled to antedate such disclosure by virtue of prior disclosure. Moreover, with respect to any term that is presented in one or more publications that is similar to, or identical with, a term that has been expressly defined in this disclosure, the definition of the term as expressly provided in this disclosure will control in all respects.

As used herein, a wavy line intersecting another line that is connected to an atom indicates that this atom is covalently bonded to another entity that is present but not being depicted in the structure. A wavy line that does not intersect a line but is connected to an atom indicates that this atom is interacting with another atom by a bond or some other type of identifiable association.

As used herein, a bond indicated by a straight line and a dashed line indicates a bond that may be a single covalent bond or alternatively a double covalent bond.

As used herein, the term “alkyl” includes a chain of carbon atoms, which is optionally branched. For purposes of this disclosure, the term “alkyl” refers to an alkyl group that contains 1 to 60 carbon atoms. Where if the alkyl group contains more than 1 carbon, the carbons may be connected in a linear manner, or alternatively if there are more than 2 carbons then the carbons may also be linked in a branched fashion so that the parent chain contains one or more secondary, tertiary, or quaternary carbons. An alkyl may be substituted or unsubstituted, unless stated otherwise. Specific substituted alkyl groups include haloalkyl groups, particularly trihalomethyl groups, such as trifluoromethyl groups. As used herein, the term “alkenyl” and “alkynyl” includes a chain of carbon atoms, which is optionally branched, and includes at least one double bond or triple bond, respectively. It is to be understood that alkenyl may also include one or more double bonds. It is to be further understood that in certain embodiments, alkyl is advantageously of limited length, including C₄-C₆₀, C₆-C₅₀, C₈-C₃₆, C₁₀-C₂₄, and C₁₂-C₂₀.

For purposes of this disclosure, the term “alkenyl” refers to an alkenyl group that contains 1 to 60 carbon atoms. While a C₁-alkenyl can form a double covalent bond to a carbon of a parent chain, an alkenyl group of three or more carbons can contain more than one double covalent bond. It certain instances the alkenyl group will be conjugated, in other cases an alkenyl group will not be conjugated, and yet other cases the alkenyl group may have stretches of conjugation and stretches of nonconjugation. Additionally, if there is more than 1 carbon, the carbons may be connected in a linear manner, or alternatively if there are more than 2 carbons then the carbons may also be linked in a branched fashion so that the parent chain contains one or more secondary, tertiary, or quaternary carbons. An alkenyl may be substituted or unsubstituted, unless stated otherwise.

For purposes of this disclosure, the term “alkynyl” refers to an alkynyl group that contains 1 to 60 carbon atoms. While a C₁-alkynyl can form a triple covalent bond to a carbon of a parent chain, an alkynyl group of three or more carbons can contain more than one triple covalent bond. Where if there is more than 1 carbon, the carbons may be connected in a linear manner, or alternatively if there are more than 3 carbons then the carbons may also be linked in a branched fashion so that the parent chain contains one or more secondary, tertiary, or quaternary carbons. An alkynyl may be substituted or unsubstituted, unless stated otherwise.

As used herein, the term “aryl” includes monocyclic and polycyclic aromatic carbocyclic groups, each of which may be optionally substituted. Illustrative aromatic carbocyclic groups described herein include, but are not limited to, phenyl, naphthyl, and the like. As used herein, the term “heteroaryl” includes aromatic heterocyclic groups, each of which may be optionally substituted. Illustrative aromatic heterocyclic groups include, but are not limited to, pyridinyl, pyrimidinyl, pyrazinyl, triazinyl, tetrazinyl, quinolinyl, quinazolinyl, quinoxalinyl, thienyl, pyrazolyl, imidazolyl, oxazolyl, thiazolyl, isoxazolyl, isothiazolyl, oxadiazolyl, thiadiazolyl, triazolyl, benzimidazolyl, benzoxazolyl, benzthiazolyl, benzisoxazolyl, benzisothiazolyl, and the like.

As used herein, the terms “optionally substituted aryl” and “optionally substituted heteroaryl” include the replacement of hydrogen atoms with other functional groups on the aryl or heteroaryl that is optionally substituted. Such other functional groups illustratively include, but are not limited to, amino, hydroxy, halo, thio, alkyl, haloalkyl, heteroalkyl, aryl, arylalkyl, arylheteroalkyl, heteroaryl, heteroarylalkyl, heteroarylheteroalkyl, nitro, sulfonic acids and derivatives thereof, carboxylic acids and derivatives thereof, and the like. Illustratively, any of amino, hydroxy, thio, alkyl, haloalkyl, heteroalkyl, aryl, arylalkyl, arylheteroalkyl, heteroaryl, heteroarylalkyl, heteroarylheteroalkyl, and/or sulfonic acid is optionally substituted.

As used herein, the term “cycloalkyl” includes a chain of carbon atoms, which is optionally branched, where at least a portion of the chain in cyclic. It is to be understood that cycloalkylalkyl is a subset of cycloalkyl. It is to be understood that cycloalkyl may be polycyclic. Illustrative cycloalkyl include, but are not limited to, cyclopropyl, cyclopentyl, cyclohexyl, 2-methylcyclopropyl, cyclopentyleth-2-yl, adamantyl, and the like. As used herein, the term “cycloalkenyl” includes a chain of carbon atoms, which is optionally branched, and includes at least one double bond, where at least a portion of the chain in cyclic. It is to be understood that the one or more double bonds may be in the cyclic portion of cycloalkenyl and/or the non-cyclic portion of cycloalkenyl. It is to be understood that cycloalkenylalkyl and cycloalkylalkenyl are each subsets of cycloalkenyl. It is to be understood that cycloalkyl may be polycyclic. Illustrative cycloalkenyl include, but are not limited to, cyclopentenyl, cyclohexylethen-2-yl, cycloheptenylpropenyl, and the like. It is to be further understood that chain forming cycloalkyl and/or cycloalkenyl is advantageously of limited length, including C₄-C₆₀, C₆-C₅₀, C₈-C₃₆, C₁₀-C₂₄, and C₁₂-C₂₀. It is appreciated herein that shorter alkyl and/or alkenyl chains forming cycloalkyl and/or cycloalkenyl, respectively, may less steric bulk and less solubilization capacity to the graphene and accordingly the graphene quantum dot will have different solution and surface-bound characteristics.

As used herein, the term “heteroalkyl” includes a chain of atoms that includes both carbon and at least one heteroatom, and is optionally branched. Illustrative heteroatoms include nitrogen, oxygen, and sulfur. In certain variations, illustrative heteroatoms also include phosphorus, and selenium. As used herein, the term “cycloheteroalkyl” including heterocyclyl and heterocycle, includes a chain of atoms that includes both carbon and at least one heteroatom, such as heteroalkyl, and is optionally branched, where at least a portion of the chain is cyclic. Illustrative heteroatoms include nitrogen, oxygen, and sulfur. In certain variations, illustrative heteroatoms also include phosphorus, and selenium. Illustrative cycloheteroalkyl include, but are not limited to, tetrahydrofuryl, pyrrolidinyl, tetrahydropyranyl, piperidinyl, morpholinyl, piperazinyl, homopiperazinyl, quinuclidinyl, and the like.

For purposes of this disclosure, the term “heterocycle” refers to ring structures that contain at least 1 noncarbon ring atom. A “heterocycle,” as used herein, encompasses from 1 to 7 heterocycle rings wherein when the heterocycle is greater than 1 ring the heterocycle rings are joined so that they are linked, fused, or a combination thereof. A heterocycle may be aromatic or nonaromatic, or in the case of more than one heterocycle ring, one or more rings may be nonaromatic, one or more rings may be aromatic, or a combination thereof. A heterocycle may be substituted or unsubstituted, or in the case of more than one heterocycle ring one or more rings may be unsubstituted, one or more rings may be substituted, or a combination thereof. Typically, the noncarbon ring atom is N, O, S, Si, Al, B, or P. In case where there is more than one noncarbon ring atom, these noncarbon ring atoms can either be the same element, or combination of different elements, such as N and O. Examples of heterocycles include, but are not limited to: a monocyclic heterocycle such as, aziridine, oxirane, thiirane, azetidine, oxetane, thietane, pyrrolidine, pyrroline, imidazolidine, pyrazolidine, pyrazoline, dioxolane, sulfolane 2,3-dihydrofuran, 2,5-dihydrofuran tetrahydrofuran, thiophane, piperidine, 1,2,3,6-tetrahydro-pyridine, piperazine, morpholine, thiomorpholine, pyran, thiopyran, 2,3-dihydropyran, tetrahydropyran, 1,4-dihydropyridine, 1,4-dioxane, 1,3-dioxane, dioxane, homopiperidine, 2,3,4,7-tetrahydro-1H-azepine homopiperazine, 1,3-dioxepane, 4,7-dihydro-1,3-dioxepin, and hexamethylene oxide; and polycyclic heterocycles such as, indole, indoline, isoindoline, quinoline, tetrahydroquinoline, isoquinoline, tetrahydroisoquinoline, 1,4-benzodioxan, coumarin, dihydrocoumarin, benzofuran, 2,3-dihydrobenzofuran, isobenzofuran, chromene, chroman, isochroman, xanthene, phenoxathiin, thianthrene, indolizine, isoindole, indazole, purine, phthalazine, naphthyridine, quinoxaline, quinazoline, cinnoline, pteridine, phenanthridine, perimidine, phenanthroline, phenazine, phenothiazine, phenoxazine, 1,2-benzisoxazole, benzothiophene, benzoxazole, benzthiazole, benzimidazole, benztriazole, thioxanthine, carbazole, carboline, acridine, pyrolizidine, and quinolizidine. In addition to the polycyclic heterocycles described above, heterocycle includes polycyclic heterocycles wherein the ring fusion between two or more rings includes more than one bond common to both rings and more than two atoms common to both rings. Examples of such bridged heterocycles include quinuclidine, diazabicyclo[2.2.1]heptane and 7-oxabicyclo[2.2.1]heptane.

For purposes of this disclosure, the terms “heterocyclic group”, “heterocyclic moiety”, “heterocyclic”, or “heterocyclo” used alone or as a suffix or prefix, refer to a heterocycle that has had one or more hydrogens removed therefrom.

For purposes of this disclosure, the term “hetero-” when used as a prefix, such as, hetero-alkyl, hetero-alkenyl, hetero-alkynyl, or hetero-hydrocarbon, refers to the specified hydrocarbon group having one or more carbon atoms replaced by one or more non carbon atoms. Examples of such non carbon atoms include, but are not limited to, N, O, S, Si, Al, B, and P. If there is more than one non carbon atom in the hetero-chain then this atom may be the same element or may be a combination of different elements, such as N and O.

The term “optionally substituted” as used herein includes the replacement of hydrogen atoms with other functional groups on the radical that is optionally substituted. Such other functional groups illustratively include, but are not limited to, amino, hydroxyl, halo, thiol, alkyl, haloalkyl, heteroalkyl, aryl, arylalkyl, arylheteroalkyl, heteroaryl, heteroarylalkyl, heteroarylheteroalkyl, nitro, sulfonic acids and derivatives thereof, carboxylic acids and derivatives thereof, and the like. Illustratively, any of amino, hydroxyl, thiol, alkyl, haloalkyl, heteroalkyl, aryl, arylalkyl, arylheteroalkyl, heteroaryl, heteroarylalkyl, heteroarylheteroalkyl, and/or sulfonic acid is optionally substituted.

The rapid expansion of data-intensive information technology has highlighted the urgent need for a successor to the silicon based complementary metal-oxide-semiconductor (CMOS) integrated circuit (IC) architecture. Carbon-based low-dimensional materials offer the prospect to boost transistor scaling, speed, and energy efficiency for future IC generations far beyond current predictions based on Moore's Law.

Extensive research into the leading low dimensional materials, carbon nanotubes (CNTs) and semiconductor nanowires (SNWs) has failed to deliver material solutions to the challenging questions of reproducible fabrication, scaling, and control over the electronic structure. The technical approaches used in the fabrication of CNTs and SNWs rely on bottom-up strategies that cannot deliver the absolute structural control required to reproducibly fabricate functional materials with homogeneous dimensions and electronic structures. CNTs for example cannot be obtained as semiconductors with uniform band gaps. Nanometer scale SNWs suffer from drastically decreased charge carrier transport properties due to uncontrollable heterogeneities in the placement of atoms along the structure of the nanowire.

Since its discovery in the mid-1960s, the development of stable, well-defined, and functional-group-tolerant olefin metathesis catalysts has greatly influenced the fields of organic synthesis and polymer and materials science. Although alkene metathesis has found a wide range of applications, alkyne metathesis has only recently become the focus of attention. Moreover, living ring-opening olefin metathesis polymerization (ROMP) has had a great impact in the areas of biomimetic synthetic polymers, self-assembled nanomaterials, and monolithic supports. Despite recent synthetic advances toward highly functionalized ring-strained alkynes, the application of ring-opening alkyne metathesis polymerization (ROAMP) to the field of polymer synthesis has remained limited due to the lack of commercially available well-behaved catalysts.

Presently, poly(arylene ethynylene), used in applications ranging from molecular photonics, electronics, to sensing, can be accessed through acyclic diyne metathesis (ADIMET) polymerization of diynes using highly active molybdenum and tungsten catalysts. However, this step-growth process provides only very limited control over the polydispersity, length, and modality of the polymer product. Previous attempts at synthesizing polymers using ring-opening of strained alkynes showed polydispersities ranging from 1.1 to 7.0. While polymers with polydispersities as low as 1.1 have been obtained, the active catalyst species is poorly defined, and the reaction requires low temperatures and rigorous air-free conditions. Polymers resulting from these catalysts tend to have higher molecular weights than predicted on the basis of the monomer to catalyst loading. ¹H NMR experiments show that only a fraction of the catalyst is activated and contributes to the linear chain growth, indicating that the rate of propagation is larger than the rate of initiation (kp/ki>1). The poor selectivity of alkyne metathesis catalysts for strained over unstrained alkynes in the growing polymer chain leads to significant broadening of the polydispersity index (PDI) through chain-transfer processes and “backbiting” to form cyclic structures.

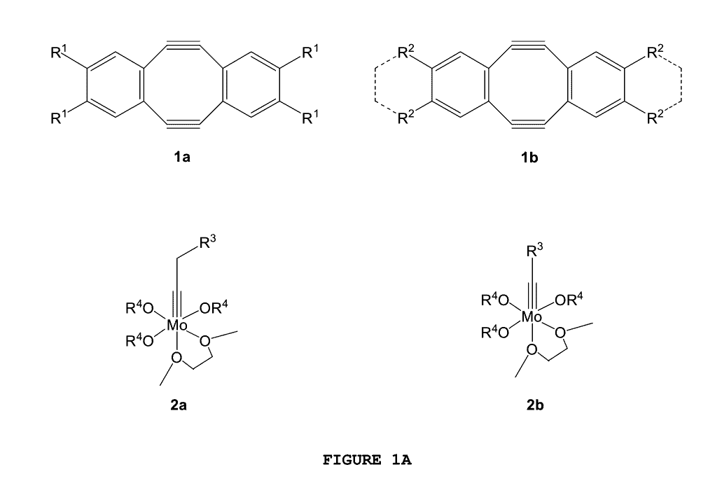

The disclosure demonstrates the synthesis and the detailed mechanistic investigation of the first molecularly defined living ring-opening alkyne metathesis catalyst [TolC≡Mo(ONO) (OR)].KOR (R═CCH₃(CF₃)₂, ONO=6,6′-(pyridine-2,6-diyl)bis(2,4-di-tert-butylphenolate)) 1 (FIG. 1B). For example, in solution, a rapid equilibrium between the -ate complex 1 and the pentacoordinate 14-electron complex 2 is observed (electron count does not include potential n-donation of electron density from alkoxide lone pairs). While the reversible association of a free alkoxide prevents undesired side reactions, the dissociation of complex 1 does not represent a rate-limiting step during the propagation. Kinetic studies reveal that the growing polymer chain efficiently limits the rate of propagation with respect to the rate of initiation (kₚ/kᵢ˜10⁻³). The disclosure further demonstrates the outstanding control over molecular weight and polydispersity achieved in living ROAMP with complex 1 and the first synthesis of block copolymers through alkyne metathesis.

In one embodiment, the methods disclosed herein allow for the production of graphene based nano-heterostructures to be chemically synthesized from the bottom up using rational polymerization methods. Graphene based hetero-nanostructures with uniform width in the 1-3 nm range, as well as atomically precise edges, can be produced through self-assembly of highly purified polyaromatic monomers. The methods of the disclosure allows for the synthesis of heterogeneous segments within a single graphene based nanostructure that have different widths and/or edge doping. Thus, new graphene based hetero-nanostructures and devices comprising the heterostructures can be produced that were heretofore unknown. The methods disclosed herein promises to produce bottom-up grown graphene based hetero-nanostructures of identical molecular structures in bulk and with high yield. The resulting single-atomic-layer nanostructure geometry is ideal for electrostatic field-effect control (even superior to CNTs).

The disclosure further provides for graphene based hetero-nanostructures produced by the methods of the disclosure, including devices comprising said graphene based hetero-nanostructures. Such devices comprise spatially contiguous graphene based hetero-nanostructures which contain covalently bonded segments of different width and/or doping. Such nanostructures can be designed to exhibit type I, type II, and p-n heterojunction behavior.

The functional graphene based hetero-nanostructures disclosed herein can be used as the channel material in post-silicon CMOS transistors, enabling the ultimate scaling of high performance digital electronics. Derivatives of the graphene based hetero-nanostructures of the disclosure can be used as highly sensitive and selective sensors for medicinal, biological, and environmental applications.

The methods disclosed herein enable the rational synthesis of nanometer scale functional electronic devices such as field effect transistors, tunneling transistors, diodes, etc. within individual graphene hetero-nanostructures (e.g., nanoribbons). Electronic devices based on the graphene based hetero-nanostructures of the disclosure have the potential to achieve significantly lower on/off switching voltages paving the way to more energy efficient and significantly faster integrated circuit architectures.

A catalyst (e.g., a catalyst of 2a-d) can be synthesized according to the scheme shown in FIG. 1B. Briefly, catalyst 2c was synthesized through ligand exchange from the trisalkoxy molybdenum benzylidyne complex [TolC≡Mo(OR)3(dme)] 3. While structurally related 12-electron molybdenum and tungsten complexes have been reported as catalysts for alkyne cross-metathesis and ring-closing metathesis, these highly active complexes are unsuitable for controlled ROAMP. Extensive chain transfer reactions lead to undesired broad weight distributions (PDI>2). In an effort to increase the selectivity of the catalyst for the activation of strained monomers over unstrained alkynes in the growing polymer chain, a permanent electron donating, sterically demanding ONO pincer ligand was used. This tridentate ligand stabilizes the high oxidation state of the molybdenum benzylidyne complex, prevents its dimerization in solution, and irreversibly blocks one of the catalyst's active sites. Deprotonation of the ONO pincer ligand with potassium benzyl followed by addition to [TolC≡Mo(OR)3(dme)] in toluene quantitatively converted 3 to the desired product 2c, by ¹H and ¹⁹F NMR spectroscopy.

### EXAMPLES

Materials and General Methods. Unless otherwise stated, all manipulations of air and/or moisture sensitive compounds were performed in oven-dried glassware, under an atmosphere of Ar or N₂. Solvents were dried by passing through a column of alumina and were degassed by vigorous bubbling of N2 or Ar through the solvent for 20 min. All ¹H, {¹H}¹³C, and ¹⁹F NMR spectra were recorded on Bruker AV-600, DRX-500, AV-500, and AV-900 MHz spectrometers, and are referenced to residual solvent peaks (CDCl₃ 1H NMR δ=7.26 ppm, ¹³C NMR δ=77.16 ppm; C₆D₆ ¹H NMR δ=7.16 ppm, ¹³C NMR δ=128.06 ppm; Tol-d₈ ¹H NMR δ=2.08 ppm; THF-d₈ ¹H NMR δ=1.78 ppm, ¹³C NMR δ=67.21 ppm) or trifluorotoluene (¹⁹F NMR δ=−63.72 ppm). The concentrations of 1, 2, 6, 7, and KOCCH₃(CF₃)₂ were determined by ¹⁹F NMR using the ERETIC method against an external standard of 13.6 mM trifluorotoluene in Tol-d₈. The concentration of monomer 5a,b was verified by ¹H NMR applying the ERETIC method against an external standard of 19.4 mM of hexamethyldisiloxane in Tol-d₈. Selective inversion recovery (SIR) experiments were performed using TopSpin for data acquisition, and fitted with CIFIT. The temperature in all VT NMR experiments is calibrated to ethylene glycol or MeOH standards. ESI mass spectrometry was performed on a Finnigan LTQFT (Thermo) spectrometer in positive ionization mode. MALDI mass spectrometry was performed on a Voyager-DE PRO (Applied Biosystems Voyager System 6322) in positive mode using a matrix of dithranol. Elemental analysis (CHN) was performed on a PerkinElmer 2400 Series II combustion analyzer (values are given in %). Gel permeation chromatography (GPC) was carried out on a LC/MS Agilent 1260 Infinity set up with a guard and two Agilent Polypore 300 mm×7.5 mm columns at 35° C. and calibrated to narrow polydispersity polystyrene standards ranging from Mw=100 to 4 068 981. X-ray crystallography was performed on APEX II QUAZAR, using a Microfocus Sealed Source (Incoatec IμS; Mo Kα radiation), Kappa Geometry with DX (Bruker-AXS build) goniostat, a Bruker APEX II detector, QUAZAR multilayer mirrors as the radiation monochromator, and Oxford Cryostream 700 for 1. Crystallographic data were refined with SHELXL-97, solved with SIR-2007, visualized with ORTEP-32, and finalized with WinGX. KBn43 were synthesized following literature procedures.

Preparation of [TolC≡Mo(ONO)(OCCH₃(CF₃)₂)].KOCCH₃(CF₃)₂.iPr₂O (2c). A 25 mL vial was charged with 4 (88 mg, 0.18 mmol, 1.0 equiv) in dry toluene (3 mL). A suspension of KBn (48 mg, 0.37 mmol 2.05 equiv) in dry toluene (8 mL) was added dropwise and the reaction mixture stirred for 15 min at 24° C. The resulting suspension was added dropwise to a solution of 3 (164 mg, 0.2 mmol, 1.1 equiv) in toluene (7 mL). An immediate color change to dark brown was observed, and the reaction mixture was stirred for 30 h at 24° C. The suspension was filtered, and the solvent was removed under dynamic vacuum. The precipitate was dissolved in cold CH₂Cl₂/pentane (3:2, 4 mL) and filtered through a precooled frit. iPr₂O (1 mL) was added to the solution, and the solvent was removed under vacuum. The residue was recrystallized from iPr₂O (2 mL) (−35° C.), to yield pure 1 (78 mg, 36%) as a dark brown crystalline solid. Crystals for X-ray analysis were grown from saturated iPr₂O solutions at −35° C. In toluene, 1 is in equilibrium with the dissociated pentacoordinate complex and free KOC(CF₃)₂CH₃. ¹H NMR (500 MHz, Tol-d₈, 22° C.) δ=7.70 (2), 7.63 (s, 2H, Ar—H), 7.42 (s, 2H, Ar—H), 7.27 (2), 7.20 (d, J=8.0 Hz, 2H, 3,5-NC₅H₂H), 6.91 (t, J=8.0 Hz, ¹H, 4-NC₅H₂H), 6.58 (d, J=7.6 Hz, 2H, C₆H₂ H₂CH₃), 6.44 (2), 6.30 (d, J=7.6 Hz, 2H, C6H₂H₂CH₃), 6.26 (2), 2.01 (s, 3H, C₆H₄—CH₃), 1.93 (s, 3H, OC (CF₃)₂CH₃), 1.71 (2), 1.64 (s, 18H, ^{t}Bu-H) 1.46 (s, 18H, tBu-H), 1.37 (2), 1.00 (s, 3H, K—OC(CF₃)₂CH₃) ppm. 19F NMR (470 MHz, Tol-d₈, 22° C.) δ=−76.79 (2), −77.80, −78.26, −81.18 (dissociated KOC(CF₃)₂CH₃) ppm. In THF, only the dissociated species 2.THF is observed, resulting in the presence of free KOC(CF₃)₂CH₃. ¹H NMR (500 MHz, THF-d₈, 22° C.) δ=7.92 (t, J=8.0 Hz, 1H, 4-NC₅H₂H), 7.70 (d, J=8.0 Hz, 2H, 3,5-NC₅H₂H), 7.52 (d, J=2.3 Hz, 2H, Ar—H), 7.46 (d, J=2.3 Hz, 2H, Ar—H), 6.74 (d, J=7.9 Hz, 2H, C₆H₂ H₂CH₃), 6.12 (d, J=7.9 Hz, 2H, C₆H₂H₂CH₃), 2.20 (s, 3H, C₆H₄CH₃), 1.78 (s, 3H, OC(CF₃)₂CH₃), 1.52 (s, 18H, tBu-H), 1.39 (s, 18H, tBu-H) ppm. {1H}¹³C NMR (126 MHz, THF-d₈, 22° C.) δ=307.5, 166.2, 155.6, 141.5, 140.5, 139.1, 138.8, 137.5, 136.8, 130.3, 127.6, 126.0, 125.4, 124.9, 123.1, 84.2, 36.0, 34.8, 32.4, 30.8, 23.5, 21.6 ppm. 19F NMR (470 MHz, THF-d8, 22° C.) δ=−76.92 ppm. FTMS (ESI-TOF) (m/z): [[TolC≡Mo(ONO) (OCCH₃(CF₃)₂)]+H]+calcd [C₄₅H₅₄—F₆MoNO₃], 868.3056; found 868.3076. Anal. Calc'd for [[TolC≡Mo (ONO) (OCCH₃(CF₃)₂)₂]KOiPr₂]₂.iPr₂O: C, 56.21; H, 6.26; N, 1.13. Found: C, 56.04; H, 6.40; N, 1.38. Crystal data: CCDC no., 998197; formula, 60.5H₈₃F₁₂KMoNO_{6.25}; fw, 1297.32 g mol⁻¹; temp, 100(2) K; cryst syst, monoclinic; space group, P21/n; color, black; a, 12.751(5) Å; b, 29.140(5) Å; c, 17.008(5) Å; α, 90.000(5)°; β, 93.406(5)°; γ, 90.000(5)°; V, 6308(3) Å 3; Z, 4; R1, 0.0367; wR2, 0.0818; GOF, 1.051.

Dark brown crystals of 2c were isolated in 36% yield after recrystallization from diisopropyl ether at −35° C. The geometry at the metal center is pseudo-octahedral. X-ray crystallography of 2c (FIG. 1B) confirms the presence of a C(1)≡Mo(1) triple bond with bond length of 1.760(2) Å and C(2)—C(1)—Mo(1) angle of 176.91 (19)°. The tridentate ONO pincer ligand adopts a skewed conformation featuring typical Mo(1)—O(1) and Mo(1)—O(3) distances of 1.9876(16) and 2.0010(16) Å, respectively. The Mo(1)—N(1) distance of 2.2227(19) Å corresponds to a neutral L-type N—Mo bond, indicating the presence of an interaction between the lone pair of the pyridine ring and the metal center. The presence of two alkoxides and one potassium cation in the crystal structure of 2c confirms that only one alkoxide in 3 has been displaced by the ONO pincer ligand. The Mo—O distances are 2.0038(16) and 2.2475(16) Å for the hexafluorotert-butoxide cis, Mo(1)—O(2), and trans, Mo(1)—O(4), to the carbyne, respectively. The elongated Mo(1)—O(4) bond for the alkoxide trans to the carbyne suggests a weak interaction with an oxygen lone pair.

Crystals of 2c are stable in air for hours and can be stored for indefinite time under an atmosphere of nitrogen. In the absence of moisture and air, a solution of 2c in toluene-d₈ shows less than 5% decomposition after one month at 24° C. In toluene d₈, the pseudo-octahedral-ate complex 2c is in dynamic equilibrium with the dissociated pentacoordinate complex [TolC≡Mo(ONO) (OR)] (R≡CCH₃(CF₃)₂)₂. In THF-d₈ the alkoxide trans to the carbyne is replaced by the solvent, and only a single species, corresponding to a THF bound hexacoordinate complex, is observed by ¹H and ¹⁹F NMR.

Preparation of poly-3,8-Dihexyloxy-5,6-dihydro-11,12-didehydrodibenzo[a,e][8]annulene (poly-5a). The various structure are depicted in Scheme 1:

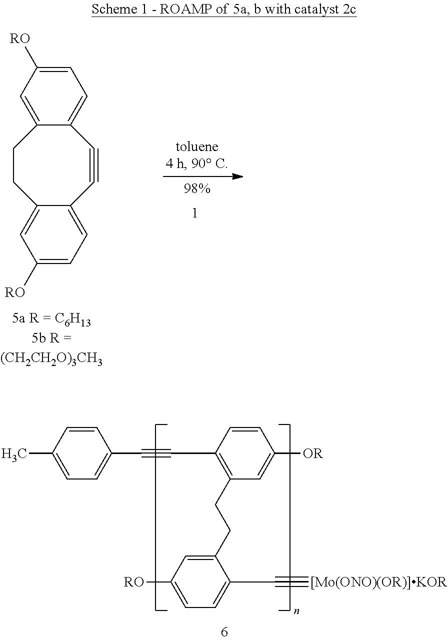

A 10 mL re-sealable Schlenk tube was charged with a stock solution of 5a (220 mM) in toluene. If required, the solution was diluted with additional dry toluene to reach a total of 0.5 mL. A stock solution of 2c (11 mM, 100 pL) in toluene was added, and the reaction mixture was heated in a bath at 90° C. for 2 h. The reaction mixture was cooled, and polymers were precipitated with MeOH (2 mL). The precipitate was filtered, washed with MeOH (2 mL), and dried in vacuum to yield poly-5a (92% isolated yield) as a pale brown solid. ¹H NMR (600 MHz, CDCl₃, 22° C.) δ=7.40 (d, J=8.4 Hz, 2H, Ar—H), 6.77-6.52 (m, 4H, Ar—H), 3.67 (t, J=6.5 Hz, 4H, OCH₂), 3.19 (s, 4H, CH₂), 1.69-1.58 (m, 4H, O(CH₂)5CH₃), 1.41-1.19 (m, 12H, O(CH₂)5CH₃), 0.87 (t, J=7.0 Hz, 6H, CH₃) ppm. {1H}₁₃C NMR (151 MHz, CDC13, 22° C.) δ=159.2, 145.3, 133.5, 115.3, 114.6, 113.0, 90.5, 67.9, 36.6, 31.8, 29.4, 25.9, 22.8, 14.2 ppm.

Addition of 2c to a solution of 5a in toluene ([5a]/[1]=10) at 24° C. does not lead to the formation of polymeric species within 24 h. ¹H and ¹⁹F NMR indicate that the ROAMP catalyst 2c quantitatively initiates with a half-life of t_{1/2}<5 min with 1 equiv of 5a to form the initiated complex 6 (n=1) (Scheme 1). At 90° C., however, the initiation reaction is instantaneous, and the living ROAMP of monomer 5a (10 equiv) in toluene is completed in less than 2 h, as determined by ¹H NMR spectroscopy. In the absence of monomer, the molybdenum catalyst attached to the propagating polymer chain remains active and continues to incorporate equivalents of monomer added sequentially to the reaction mixture. Precipitation of the resulting polymers in MeOH affords poly-5a in greater than 90% isolated yield. GPC analysis for various monomer/catalyst loadings at 90° C. in toluene shows a PDI of ˜1.02, the lowest value ever reported for ROAMP (Table 1). Extended reaction times do not lead to a deterioration of the PDI. The molecular weights of poly-5a determined by GPC, calibrated to polystyrene standards, scale linearly with the conversion of monomer, are proportional to the initial [5a]/[2c] loading, and show a unimodal distribution. No evidence for branching or the formation of cyclic polymers could be observed by ¹H NMR analysis and mass spectrometry. ¹H NMR end-group analysis of the tolyl group reveals that GPC overestimates the Mn of poly-5a. A correction factor ˜0.7-1.0 correlates well with the degree of polymerization determined by NMR analysis and the expected molecular weight based on the [5a]/[2c] loading.

TABLE 1
Molecular Weight Analysis of poly-5a

| [5a]/[1] | T (° C.) | Mₙ theory | Mₙ GPC^{a} | M_{w} GPC^{a} | Xₐ^{b} | PDI GPC^{a} |
|---|---|---|---|---|---|---|
| 10/1 | 60 | 4000 | 7200 | 7700 | | 1.07 |
| 10/1 | 70 | 4000 | 7300 | 7800 | | 1.07 |
| 10/1 | 80 | 4000 | 9100 | 9500 | | 1.04 |
| 10/1 | 90 | 4000 | 6100 | 6600 | 11 | 1.08 |
| 20/1 | 90 | 8100 | 11 400 | 11 800 | 23 | 1.03 |
| 50/1 | 90 | 20 200 | 21 500 | 22 100 | 47 | 1.02 |
| 100/1 | 90 | 40 400 | 40 600 | 41 500 | 99 | 1.02 |

^{a}Calibrated to narrow polydispersity polystrene standards.
^{b}Degree of polymerization determined by ¹H NMR end-group analysis.

A proposed kinetic scheme for the polymerization of a ring-strained monomer with a catalyst (e.g., 2c) is depicted in Scheme 2:

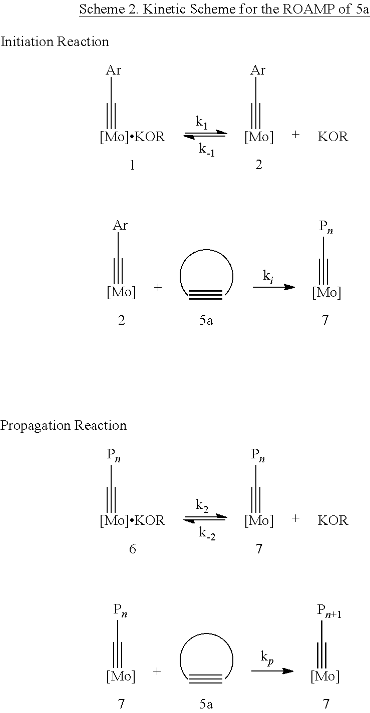

In a fast initiation reaction, 1 equiv of 5a reacts with 2 to form the initiated complex 7 (n=1). Binding of KOR to 7 stabilizes the initiated complex and reversibly blocks the active site. Dissociation of KOR from 6 regenerates the active propagating species that undergoes linear chain-growth polymerization with further equivalents of 5a to form extendedliving polymer chains.

Preparation of poly-3,8-Di-(2-(2-(2-methoxyethoxy) ethoxy)-ethoxy)-5,6-dihydro-11,12-didehydrodibenzo[a,e][8]annulene(poly-5b). A 10 mL resealable Schlenk tube was charged with a stock solution of 5b (220 mM) in toluene. If required, the solution was diluted with additional dry toluene to reach a total of 0.5 mL. A stock solution of 2c (11 mM, 100 μL) in toluene was added, and the reaction mixture was heated in a bath at 90° C. for 7 h. The reaction mixture was concentrated and the solid residue suspended in cold MeOH (2 mL). The precipitate was filtered, washed with cold MeOH (2 mL), and dried in vacuum to yield poly-5b (53% isolated yield) as a pale orange solid. ¹H NMR (900 MHz, CDCl₃, 22° C.) δ=7.38 (s, 2H, Ar—H), 6.66 (s, 4H, Ar—H), 3.91-3.24 (m, 30H), 3.17 (s, 4H, CH₂) ppm. {¹H}¹³C NMR (226 MHz, CDCl₃, 22° C.) δ=158.8, 145.1, 133.6, 115.7, 114.8, 113.1, 90.6, 72.0, 70.9, 70.7 (2C), 69.7, 67.4, 59.2, 36.2 ppm.

Preparation of poly-5a-block-poly-5b. A 10 mL re-sealable Schlenk tube was charged with a stock solution of 5a (230 mM, 200 μL) in toluene. A stock solution of 2c (7.7 mM, 300 μL) in toluene was added, and the reaction mixture was heated at 90° C. for 30 min. An aliquot (150 μL) was quickly removed and precipitated with MeOH (2 mL). A stock solution of 5b (46 mM, 700 μL) in toluene was added, and the reaction was heated for an additional 7 h. The reaction mixture was cooled, and polymers were precipitated with MeOH (2 mL). The precipitate was filtered, washed with MeOH (2 mL), and dried in vacuo to yield poly-5a-block-poly-5b (94% isolated yield) as a pale orange solid. ¹H NMR (500 MHz, CDCl₃, 22° C.) δ=7.40 (d, J=8.4 Hz, 4H, Ar—H), 6.79-6.42 (m, 8H, Ar—H), 4.19-3.42 (m, 34H), 3.18 (s, 8H, CH₂), 1.79-1.49 (m, 4H, O(CH₂)₅CH₃), 1.40-1.16 (m, 12H, O(CH₂)₅CH₃), 0.86 (t, J=6.9 Hz, 6H, CH₃) ppm. {¹H}¹³C NMR (126 MHz, CDCl₃, 22° C.) δ=159.2, 145.2, 133.4, 115.2, 114.5, 113.0, 90.4, 72.0, 70.9, 70.7 (2C), 69.7 (2C), 67.9, 59.2, 36.6, 31.8, 29.4, 25.9, 22.8, 14.2 ppm.

Bottom-up synthesis of atomically defined graphene nanoribbons (GNRs) from a polymer precursor fabricated through ring-opening alkyne metathesis polymerization: Ring-strained monomer precursors of the general structure 1a (where R¹, represent hydrogen atoms, alkyl, aryl, heteroatoms, or heteroaromatic rings) or 1b (where R², represent benzannulated aromatic or aliphatic rings featuring hydrogen atoms, alkyl, aryl, heteroatoms, or heteroaromatic rings) can be subjected to ring-opening alkyne metathesis polymerization conditions using catalysts 2a (where R³ is alkyl or aryl; R⁴ is C(CH₃)₃, C(CH₃)₂(CF₃), C(CH₃) (CF₃)3, or C(CF₃)₃) and 2b (where R³ is aryl or heteroaryl, R⁴ is C(CH₃)₃, C(CH₃)₂(CF₃), C(CH₃) (CF₃)₃, or C(CF₃)₃) (see FIG. 1) .

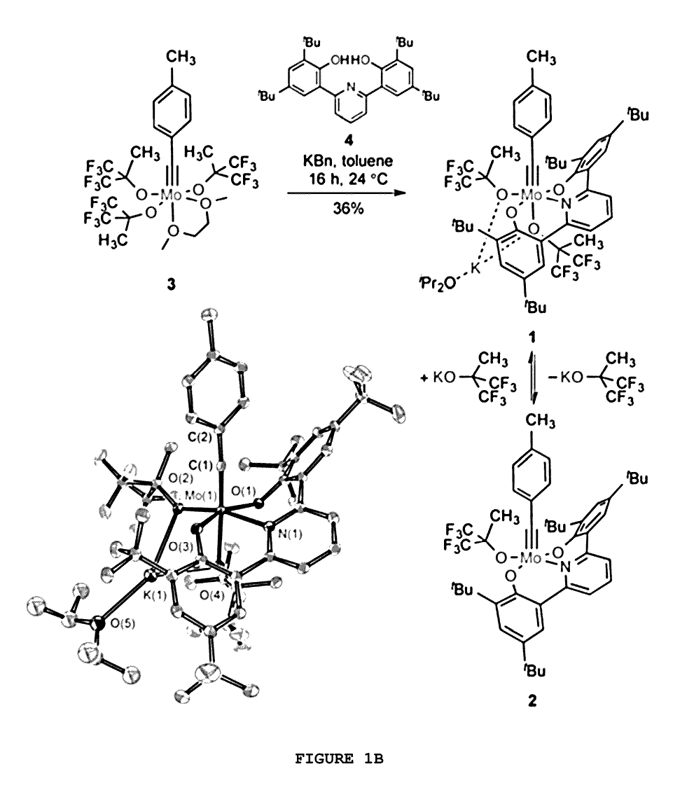

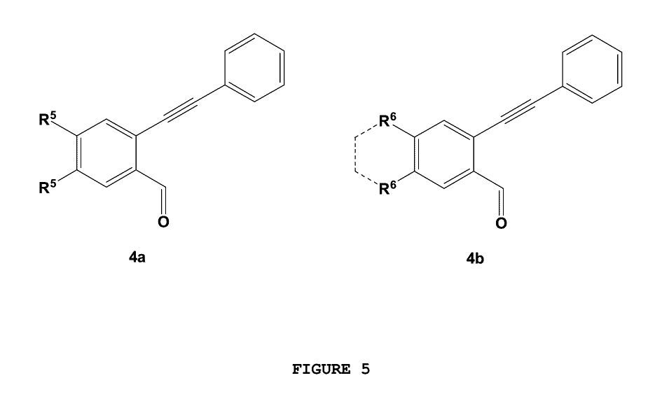

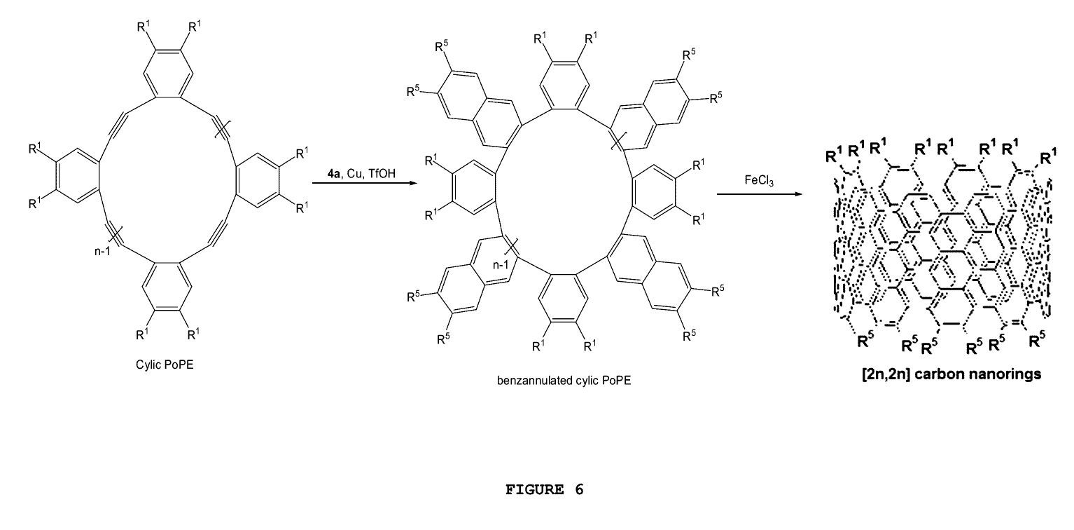

Polymerization is performed with catalyst 2a. As shown in FIG. 2, the resulting product is a mixture of cyclic and linear poly(o-phenylene ethynylene) (PoPE) (ca. 60-80% cyclic polymers). The intermediate product in the polymerization is a linear polymer that results from the ring-opening reaction of 2a with 1a and/or 1b. One end of the polymer chain is terminated by a CCH₂R³ group while the other end of the same polymer chain features the active propagating molybdenum catalyst, structure 3a. Once the monomer is consumed the active catalyst selectively bites back into the terminal alkylidyne at the opposite end of the chain yielding a cyclic polymer and regenerates the initial catalyst 2a. The resulting cyclic polymers feature between n=3-20 monomer units in the chain. Significantly longer or shorter growing polymer chains are less likely to undergo back-biting into the polymer chain-end and can be collected as linear polymers at the end of the reaction. The resulting mixture of cyclic (60-80%) and linear polymers (40-20%) can be separated by Shoxlet extraction (alkanes) of the quenched reaction mixture. The more soluble cyclic polymers are isolated from the extract. GPC traces show the characteristic structure associated with discrete cyclic PoPE. As shown in FIG. 5, the cyclic PoPE can be subjected to a benzannulation reaction with 4a or 4b (where R⁵, represent hydrogen atoms, alkyl, aryl, heteroatoms (NR₂, OR, F, Cl, Br, I, CN, NO₂), or heteroaromatic rings, and R⁶ represent benzannulated aromatic or aliphatic rings featuring hydrogen atoms, alkyl, aryl, heteroatoms (NR₂, OR, F, Cl, Br, I, CN, NO₂), or heteroaromatic rings) that converts the alkynes into benzannulated cyclic PoPE (see FIG. 6). An oxidative cyclization using for example Scholl reaction conditions yields [2n,2n] carbon nanorings that represent precisely defined segments of carbon nanotubes. The two open ends of the carbon nanorings are substituted on one side with R¹ and on the other side with R⁵ (R⁶ when 4b has been used). The choice of monomers 1a and/or 1b and benzannulating reagents 4a and/or 4b defines the width of the nanoring segments (in this case the ring measures 8 carbon atoms across).

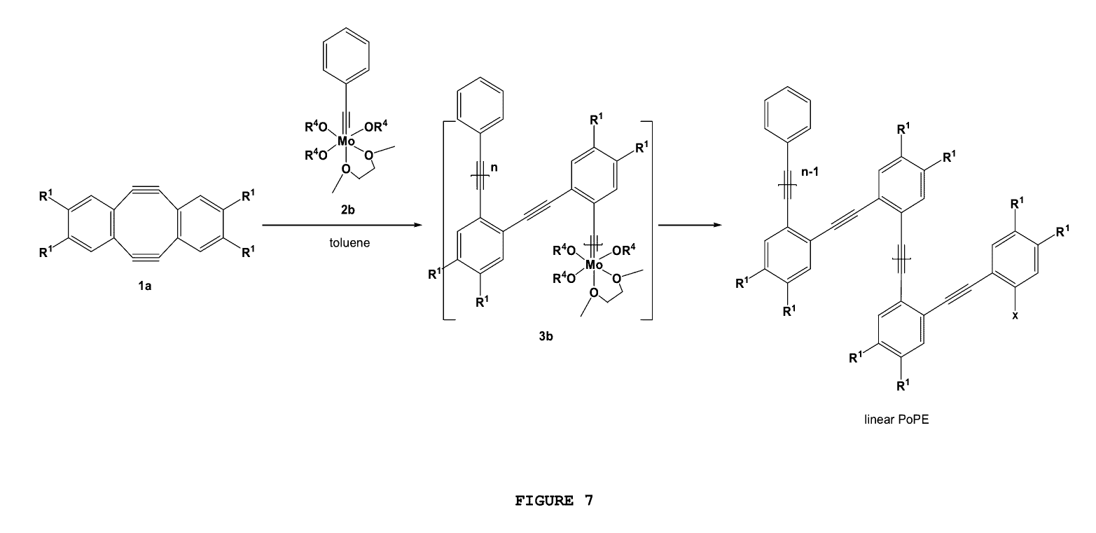

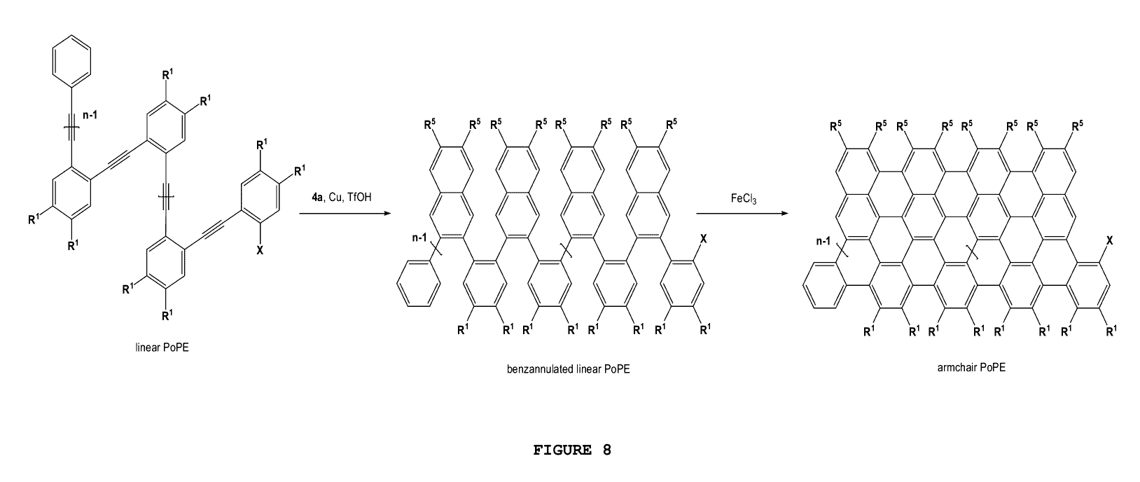

Polymerization performed with catalyst 2b: As shown in FIG. 7, the resulting product is a linear poly(o-phenylene ethynylene) (PoPE). The intermediate product in the polymerization is a linear polymer that results from the ring-opening reaction of 2b with 1a and/or 1b. One end of the polymer chain is terminated by a CR³ group while the other end of the polymer chain features the active propagating molybdenum catalyst, structure 3b. After quenching of the reaction a linear PoPE can be isolated in >95% yield. The linear PoPE can be subjected to a benzannulation reaction with 4a or 4b that converts the alkynes into benzannulated linear PoPE (see FIG. 8). An oxidative cyclization using for example Scholl reaction conditions yields armchair GNRs. The two armchair edges of the ribbons are substituted on one side with R¹ and on the other side with R⁵ (R⁶ when 4b has been used). The ability to introduce a differential edge substitution in GNRs enables the introduction of a dipole moment across the width of the ribbon. This can be used as a tool to tune the interaction with electromagnetic fields. The choice of monomers 1a and/or 1b and benzannulating reagents 4a and/or 4b defines the width of the nanoribbon (in this case N=8 AGNR). The modulation of the width provides a tool to tune the band gap of the GNR while the edge substitution can be used to increase or lower the relative position of the valence and the conductance band edges.

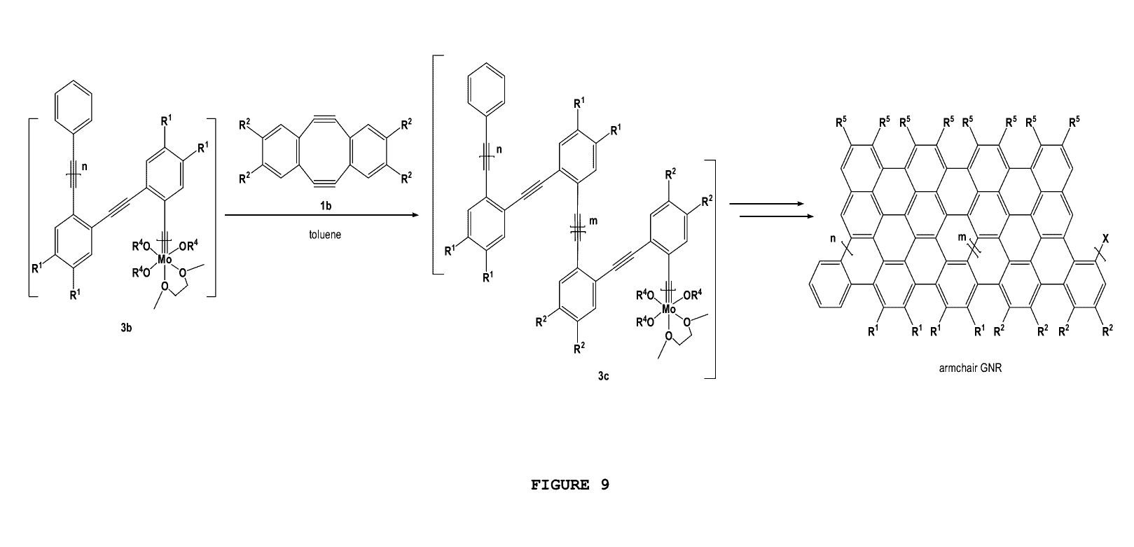

Polymerization performed with catalyst 2b to prepare segmented GNRs. The band structure in the individual segments can be controlled by the choice of ring-strained monomers 1a and/or 1b or by the controlled addition of a chain-transfer reagent that terminates the polymerization. Since the polymerization of la and/or 1b with 2b are “living” block-copolymers featuring different monomer units can be synthesized. Following the benzannulation and oxidative cyclization procedure outlined above, segmented GNRs featuring 2 or more armchair segments can be obtained (see FIG. 9). The interphase between individual segments represents a heterojunction that can, for example, perform the function of a diode or a transistor. If the propagating linear polymer chains are quenched with a mono- or polyfunctional molecule featuring one or multiple alkyn-1-yl groups the growing polymer chains can be covalently bound to a linker. Following the benzannulation and oxidative cyclization the linker is integrated into the center of the GNR. Depending on the band gap alignment between the GNR segments and the linker molecule this technique enables the efficient and high yielding fabrication of, for example, tunneling junctions within a single GNR.

A number of embodiments have been described herein. Nevertheless, it will be understood that various modifications may be made without departing from the spirit and scope of this disclosure. Accordingly, other embodiments are within the scope of the following claims.

What is claimed is:

1. A compound of structure of 2a and/or 2b: 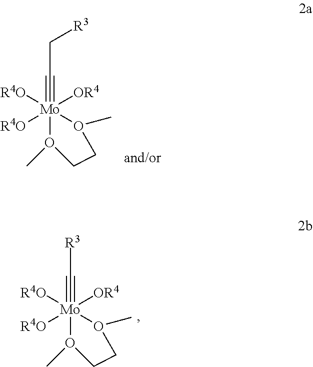
wherein,
R³ is selected from optionally substituted alkyl, optionally substituted aryl, or optionally substituted heteroaryl;
R⁴ is selected from C(CH₃)₃, C(CH₃)₂(CF₃), C(CH₃) (CF₃)₂, or C(CF₃)₃.

2. The compound of claim 1, wherein R³ is an optionally substituted aryl.

3. The compound of claim 1 or 2, wherein R⁴ is C(CH₃)(CF₃)₂

4. A method to produce a high molecular weight polymer comprising:
subjecting a ring strained cycloalkynyl monomers to ring-opening alkyne polymerization conditions in the presence of a molybdenum ring-opening alkyne metathesis polymerization (ROAMP) catalyst comprising a compound of claim 1.

5. The method of claim 4, wherein the polymerization conditions comprise a nonpolar solvent.

6. The method of claim 5, wherein the nonpolar solvent is selected from pentane, cyclopentane, hexane, cyclohexane, benzene, toluene, 1,4-dioxane, chloroform, and diethyl ether.

7. The method of claim 6, wherein the nonpolar solvent is toluene.

8. The method of claim 4, wherein the ring strained cycloalkynyl monomers is selected from the structure of 1a, 1b, and/or 1c: 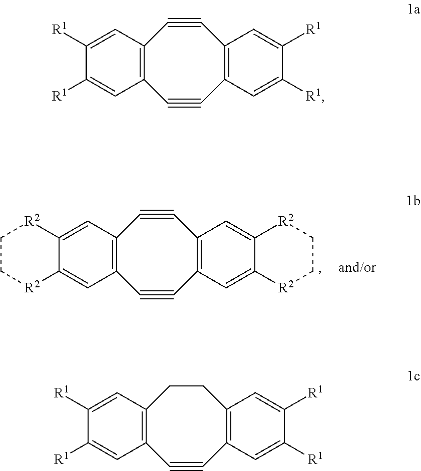
wherein
each R¹ is independently selected from hydrogen, optionally substituted alkyl, optionally substituted aryl, optionally substituted hetero-atom functional groups, or optionally substituted heteroaryl; and
each R² is independently selected from benzannulated aromatic or aliphatic rings featuring hydrogen atoms, optionally substituted alkyl groups, optionally substituted aryl groups, optionally substituted hetero-atom functional groups, or optionally substituted heteroaromatic ring groups.

9. The method of claim 8, wherein high molecular weight polymer comprises a graphene based hetero-nanostructures.

10. The method of claim 9, wherein the graphene based hetero-nanostructures produced is cyclic and/or linear poly(O-phenylene ethyneylene) (PoPE) hetero-nanostructures, wherein the cyclic PoPE hetero-nanostructures have 3 to 20 monomer units.

11. The method of claim 10, wherein the method further comprises:
separating the cyclic and linear PoPE hetero-nanostructures by Shoxlet extraction.

12. The method of claim 10, wherein the method further comprises:
subjecting the cyclic PoPE hetero-nanostructure to a benzannulation reaction with a compound of structure 4a or 4b: 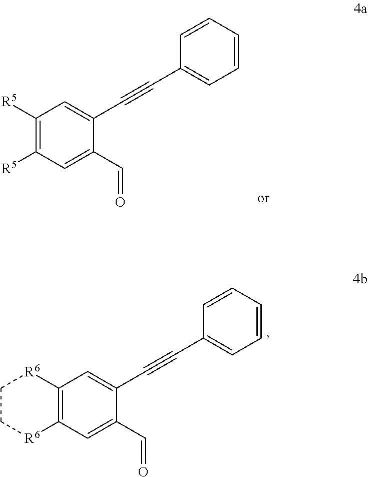
wherein,
each R⁵ is independently selected from hydrogen, optionally substituted alkyl, optionally substituted aryl, NR₂, OR, F, Cl, Br, I, CN, NO₂, and optionally substituted heteroaryl;
each R⁶ is independently selected from benzannulated aromatic or aliphatic rings featuring hydrogen atoms, optionally substituted alkyl groups, optionally substituted aryl groups, NR₂, OR, F, Cl, Br, I, CN, NO₂, and optionally substituted heteroaryl groups; and
wherein each R is independently selected from optionally substituted alkyl, optionally substituted aryl, and optionally substituted heterocycle.

13. The method of claim 12, wherein the method further comprises:
oxidative cyclizing the benzannulated cylic PoPE hetero-nanostructure under Scholl reaction conditions to yield a [2n,2n] carbon nano-ring.

14. The method of claim 13, where the [2n,2n] carbon nano-ring is substituted with R¹ groups on one side of the ring, and substituted with R⁵ groups on the other side of the ring.

15. The method of claim 10, wherein the method further comprises:
subjecting the linear PoPE hetero-nanostructure to a benzannulation reaction with a compound of structure 4a or 4b: 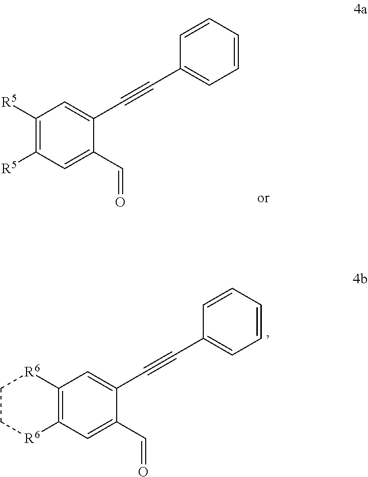
wherein,
each R⁵ is independently selected from hydrogen, optionally substituted alkyl groups, optionally substituted aryl groups, NR₂, OR, F, Cl, Br, I, CN, NO₂, and optionally substituted heteroaryl groups;
each R⁶ is independently selected from benzannulated aromatic or aliphatic rings featuring hydrogen atoms, optionally substituted alkyl groups, optionally substituted aryl groups, NR₂, OR, F, Cl, Br, I, CN, NO₂, and optionally substituted heteroaryl groups; and
wherein each R is independently selected from optionally substituted alkyl, optionally substituted aryl, and optionally substituted heterocycle.

16. The method of claim 15, wherein the method further comprises:
oxidative cyclizing the benzannulated linear PoPE hetero-nanostructure under Scholl reaction conditions to yield a graphene based nanoribbon (GNR).

17. The method of claim 13, where the two armchair edges of the GNR are substituted with R¹ groups on one side, and substituted with R⁵ or R⁶ groups on the other side.

18. The method of claim 15, wherein the method further comprises:
oxidative cyclizing the benzannulated linear PoPE hetero-nanostructure under Scholl reaction conditions to yield a segmented graphene based nanoribbon (GNR), wherein the segments comprise block-copolymers featuring different monomer units.

19. The method of claim 18, wherein the segmented graphene based nanoribbon comprises tunneling junctions.

20. A graphene based hetero-nanostructure made by claim 8.

21. A device comprising the graphene based hetero-nanostructure of claim 20.

22. The device of claim 21, wherein the device is a nanometer scale functional electronic device.

23. The device of claim 21, wherein the device is selected from a field effect transistor, tunneling transistor, and diode.
